(19) United States
(12) Patent Application Publication
(10) Pub. No.: US 2014/0126499 A1
(43) Pub. Date: May 8, 2014

(54) METHOD AND APPARATUS FOR TRANSMITTING HARQ INDICATION INFORMATION

(71) Applicant: Samsung Electronics Co., Ltd., Suwon-si (KR)

(72) Inventors: Yingyang LI, Beijing (CN); Chengjun SUN, Beijing (CN)

(73) Assignee: Samsung Electronics Co., Ltd., Suwon-si (KR)

(21) Appl. No.: 14/069,966

(22) Filed: Nov. 1, 2013

(30) Foreign Application Priority Data
Nov. 2, 2012 (CN) 201210434086.X

(51) Int. Cl. H04W 72/14

(52) U.S. Cl. CPC H04W 72/14
USPC 370/329

(57) ABSTRACT

A method for transmitting Hybrid Automatic Repeat Request (HARQ) indication information is provided. The method includes transmitting, by a User Equipment (UE), uplink data on a Physical Uplink Shared CHannel (PUSCH) according to scheduling of a base station, according to a synchronous HARQ timing relationship, detecting, by the UE, new uplink grant signaling and enhanced Physical HARQ Indicator CHannel PHICH (ePHICH) information from the base station, wherein ePHICH resources are mapped to at least parts of time frequency resources of one or multiple distributed enhanced Physical Downlink Control Channel (ePDCCH) sets, if the uplink grant signaling is not detected, one of retransmitting and not transmitting, by the UE, the uplink data. Apparatuses are also provided. By using the method and apparatuses, the ePHICH resources are effectively mapped for the uplink data transmission of the UE, and impact of the mapped ePHICH on the ePDCCH is reduced.

### CROSS-REFERENCE TO RELATED APPLICATION(S)

This application claims the benefit under 35 U.S.C. §119(a) of a Korean patent application filed on Nov. 2, 2012 in the Chinese Intellectual Property Office and assigned Serial No. 201210434086.X, the entire disclosure of which is hereby incorporated by reference.

### TECHNICAL FIELD

The present disclosure relates to mobile communication technologies. More particularly, the present disclosure relates to a method for transmitting Hybrid Automatic Repeat Request (HARQ) indication information.

### BACKGROUND

In 3^{rd} Generation Partnership Project (3GPP) Long Term Evolution (LTE) systems, the length of each radio frame is 10 ms and the radio frame is evenly divided into 10 subframes. A Transmission Time Interval (TTI) is defined in one subframe.

FIG. 1 is a schematic diagram illustrating a frame structure in a Frequency Division Duplexing (FDD) system according the related art.

Referring to FIG. 1, each downlink subframe includes two time slots, for a general Cyclic Prefix (CP) length, each time slot includes 7 Orthogonal Frequency Division Multiplexing (OFDM) symbols; for an extended CP length, each time slot includes 6 OFDM symbols.

FIG. 2 is a schematic diagram illustrating a subframe structure in a LTE system according the related art.

Referring to FIG. 2, the first n OFDM symbols, wherein n is equal to 1, 2 or 3, are used to transmit downlink control information, and include a Physical Control Format Indicator CHannel (PCFICH), a Physical HARQ Indicator Channel (PHICH) and a Physical Downlink Control CHannel (PDCCH). The remaining OFDM symbols are used to transmit Physical Downlink Shared CHannels (PDSCHs). A unit of resources assignation is a Physical Resource Block (PRB). One PRB includes 12 consecutive subcarriers in a frequency domain and corresponds to one time slot in a time domain. Two PRBs in two time slots on the same subcarrier in one subframe are referred to as a PRB pair. In each PRB pair, a minimum unit of the time frequency resources is a Resource Element (RE), i.e., a subcarrier in the frequency domain and an OFDM symbol in the time domain. The REs may be used to perform different functions respectively. For example, some of the REs may be respectively used to transmit cell-specific Common Reference Signal (CRS), user-specific DeModulation Reference Signal (DMRS) or Channel State Information Reference Signal (CSI-RS) and so on.

In the LTE system, uplink data transmission is based on a synchronous HARQ mechanism. The original transmission is triggered by a PDCCH carrying an UpLink (UL) grant signaling and the retransmission may be triggered by the UL grant signaling or the PHICH. The PHICH resources of the User Equipment (UE) are determined according to a minimum PRB index of a Physical Uplink Shared CHannel (PUSCH) and uplink reference signal indication information (n_{DMRS}) in the UL grant signaling. Specifically, each PHICH resource is indicated by an index pair (n_{PHICH}^{group},n_{PHICH}^{group}), and n_{PHICH}^{group} is a serial number of a PHICH group, n_{PHICH}^{seq} is an index of an orthogonal sequence in the PHICH group. The PHICH resources occupied by the UE are:

n_{PHICH}^{group}=(I_{PRB}_{_{—}}_{RA}^{lowest}^{_{—}}^{index}+n_{DMRS})mod N_{PHICH}^{group}+I_{PHICH}N_{PHICH}^{group}

n_{PHICH}^{seq}=(└I_{PRB}_{_{—}}_{RA}^{lowest}^{_{—}}^{index}/N_{PHICH}^{group}┘+n_{DMRS})mod 2N_{SF}^{PHICH}

Herein, n_{DMRS} is indication information of an uplink reference signal;

N_{SF}^{PHICH} is an extended factor of the PHICH channel;

I_{PRB}_{_{—}}_{RA}^{lowest}^{_{—}}^{index} is a minimum PRB index in the first time slot of the PUSCH;

N_{PHICH}^{group} is the number of the PHICH groups configured semi-statically;

$${I}_{PHICH} = \{ \begin{matrix}1 & \begin{matrix}PUSCH transmission in the subframe 4 and 9 \\ for uplink / downlink configurat ion 0 of the TDD\end{matrix} \\ 0 & other\end{matrix}$$

For the purpose of supporting larger capacity of the control channel and supporting interference cooperation of control channels of multiple cells, enhanced PDCCH (e PDCCH) is provided. The ePDCCH is sent mapped to a data area of the subframe, and a Frequency Division Multiplexing (FDM) mode is used for the ePDCCH and the PDSCH. A base station may inform the UE of the PRB pairs for transmitting the ePDCCH, and the PRB pairs for transmitting the ePDCCHs may be different for different UEs.

A concept of ePDCCH set is introduced for configuration of ePDCCH. The base station may configure the UE to detect the ePDCCH in multiple ePDCCH sets. The ePDCCH set consists of one or multiple PRB pairs. According to a method of mapping resources of the ePDCCH, the ePDCCHs may be divided into localized ePDCCHs and distributed ePDCCHs. Each ePDCCH set may be used to carry the distributed ePDCCH or be used to carry the localized ePDCCH. Each distributed ePDCCH is mapped to all PRBs in one ePDCCH set as much as possible; each localized ePDCCH is mapped to one PRB of the ePDCCH set, when an aggregation level of the localized ePDCCH is large, the localized ePDCCH may be mapped to multiple PRBs of the ePDCCH set.

In one PRB, for the purpose of multiplexing multiple ePDCCHs, except the REs used for the DMRS, all other REs are divided into RE Groups (REGs) which are referred to as an enhanced REG (eREG).

FIG. 3 is a schematic diagram illustrating a division of eREG according to the related art.

Referring to FIG. 3, in each PRB, the PRB is divided into 16 eREGs. Indexes of all eREGs are circularly mapped to REs usable for ePDCCHs in one PRB pair respectively according to a sequence of frequency first and time later. By combining multiple eREGs, a Control Channel Element (CCE) is obtained and is referred to as an enhanced CCE (eCCE). Time frequency resources occupied by one ePDCCH are obtained by combining multiple eCCEs.

In further evolution systems of the LTE system, overhead of subsequent compatible control signaling and CRSs are reduced and interference introduced by the subsequent compatible control signaling and CRSs are reduced, which is good for improving spectrum utilization of the UE. Since the overhead of the CRSs is reduced, more electrical energy is saved for the system. The ePDCCH and PDSCH transmission of this kind of system are generally based on DMRS demodulation, and is referred to as New Carrier Type (NCT).

In the NCT system, enhanced PHICH (ePHICH) needs be configured for the ePDCCH. Similar with the ePDCCH, the ePHICH is sent mapped to a data area of the subframe, and the FDM mode is used for the ePHICH and the PDSCH. In this way, when the uplink data is transmitted based on the synchronous HARQ strategy in the NCT cell, the ePHICH is used to determine whether the uplink data is received correctly or to trigger a non-adaptive retransmission of the uplink data. For example, when the NCT cell works as a Supplement Cell (SCell) in a Carrier Aggregation (CA) system and the uplink transmission of the NCT cell is scheduled by using a Self Scheduling strategy, according to a design principle of related-art protocols, the ePHICH resources need to be assigned on a cell sending uplink grant signaling, i.e., the current NCT cell. Therefore, a technical problem of how to send ePHICH in the NCT system needs to be addressed.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for transmitting Hybrid Automatic Repeat Request (HARQ) indication information, so as to effectively map enhanced Physical HARQ Indicator CHannel (ePHICH) resources for uplink data transmission of the User Equipment (UE).

In accordance with an aspect of the present disclosure, a method for transmitting HARQ indication information is provided. The method includes transmitting, by a User Equipment (UE), uplink data on a Physical Uplink Shared CHannel (PUSCH) according to scheduling of a base station, according to a synchronous HARQ timing relationship, detecting, by the UE, new uplink grant signaling and enhanced Physical HARQ Indicator CHannel PHICH (ePHICH) information from the base station, wherein ePHICH resources are mapped to at least parts of time frequency resources of one or multiple distributed enhanced Physical Downlink Control Channel (ePDCCH) sets, if the uplink grant signaling is not detected, one of retransmitting and not transmitting, by the UE, the uplink data.

Preferably, a parameter of a distributed ePDCCH set used for an ePHICH is configured for the UE via high layer signaling, which comprises one of configuring only one distributed ePDCCH set used for the ePHICH, and mapping the ePHICH resources to the distributed ePDCCH set for the UE, configuring multiple distributed ePDCCH sets used for the ePHICH, and mapping the ePHICH resources to the multiple distributed ePDCCH sets for the UE, and configuring a distributed ePDCCH set used for the ePHICH for each distributed ePDCCH set in which a ePDCCH is detected by the UE, and uplink grant signaling in the distributed ePDCCH set mapping the ePHICH resources to the corresponding distributed ePDCCH set.

Preferably, the ePHICH resources are mapped to a distributed ePDCCH set used for carrying Common Search Space (CSS) for the UE.

Preferably, the ePDCCH and the ePHICH use a same Demodulation Reference Signal (DMRS) port, and a DMRS sequence is generated according to a same cell-specific indication.

Preferably, when at least one distributed ePDCCH set in which an ePDCCH is detected is configured for the UE, the ePHICH resources are mapped to one of the distributed ePDCCH sets for the UE.

Preferably, when more than one distributed ePDCCH set in which an ePDCCH is detected is configured for the UE, for uplink grant signaling in each distributed ePDCCH set, according to the synchronous HARQ timing relationship, the ePHICH resources are mapped to the distributed ePDCCH set, or, for uplink grant signaling in each distributed ePDCCH set, the ePHICH resources are mapped to the more than one distributed ePDCCH set.

Preferably, the ePHICH resources are one of centralized mapped to one distributed ePDCCH set and evenly mapped to multiple distributed ePDCCH sets.

Preferably, the method further includes one of configuring the number of the ePHICH resources on the ePDCCH set semi-statically, and configuring the number of enhanced Control Channel Elements (eCCEs) on the ePDCCH set used for the ePHICH semi-statically.

Preferably, the method further includes configuring a maximum number of the ePHICH resources on the ePDCCH set semi-statically, wherein the eCCE not completely occupied by the ePHICH is able to transmit the ePDCCH dynamically.

Preferably, the maximum number of the ePHICH resources is implicitly determined according to a number of Physical Resource Blocks (PRBs) in uplink bandwidth and a weighting factor configured by a high layer.

Preferably, for Time Division Duplex (TDD) uplink downlink configuration 0, time frequency resources occupied by two ePHICH areas are assigned alternately.

Preferably, the ePHICH resources are carried by one eCCE are taken as one ePHICH group.

Preferably, the method further includes configuring the number of ePHICH groups by a high layer signaling, the number of the ePHICH groups is the number of ePHICH groups in one ePDCCH set used for the ePHICH, or the number of the ePHICH group is the total number of ePHICH groups in all ePDCCH sets used for the ePHICH in the base station.

Preferably, the ePHICHs of the UE are mapped to only one distributed ePDCCH set.

Preferably, different offsets are used for the uplink grant signaling of different ePDCCH sets when the ePHICHs are mapped.

Preferably, the ePHICHs of the UE are mapped to multiple distributed ePDCCH sets.

Preferably, the ePHICH resources are mapped according to a minimum eCCE index n_{eCCE} occupied by the uplink grant signaling and n_{DMRS} in the uplink grant signaling.

Preferably, the ePHICH resources are mapped according to a minimum PRB index of the PUSCH, a minimum eCCE index n_{eCCE} occupied by the uplink grant signaling and n_{DMRS} in the uplink grant signaling.

In accordance with an aspect of the present disclosure, a base station apparatus is provided. The apparatus includes a signal generating module configured to generate enhanced Physical Downlink Control CHannel (ePHICH) signals to be sent on ePHICH resources, a multiplexing module configured to map the ePHICH signals to assigned time frequency resources of one or more distributed enhanced Physical Downlink Control CHannel (ePDCCH) sets used for sending the ePHICH, a transmission module configured to transmit the mapped ePHICH signal.

In accordance with an aspect of the present disclosure, a terminal device is provided. The device includes a receiving module configured to detect and to receive a signal, a demultiplexing module configured to demultiplex the ePHICH signal from time frequency resources of a corresponding distributed ePDCCH set, a parsing module configured to parse the ePHICH signal and to obtain Hybrid Automatic Repeat Request (HARQ)-ACKnowledgement (ACK) information for uplink data.

By using the method and apparatus of the present disclosure, the ePHICH resources are effectively mapped for the uplink data transmission of the UE, and impact of the mapped ePHICH on the ePDCCH is reduced.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram illustrating a frame structure in a Frequency Division Duplexing (FDD) system according the related art.

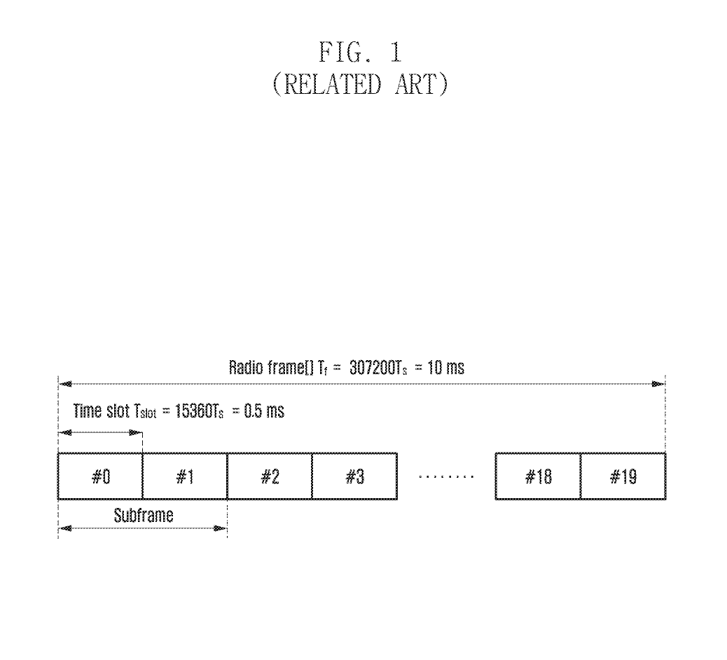

FIG. 2 is a schematic diagram illustrating a subframe according to the related art.

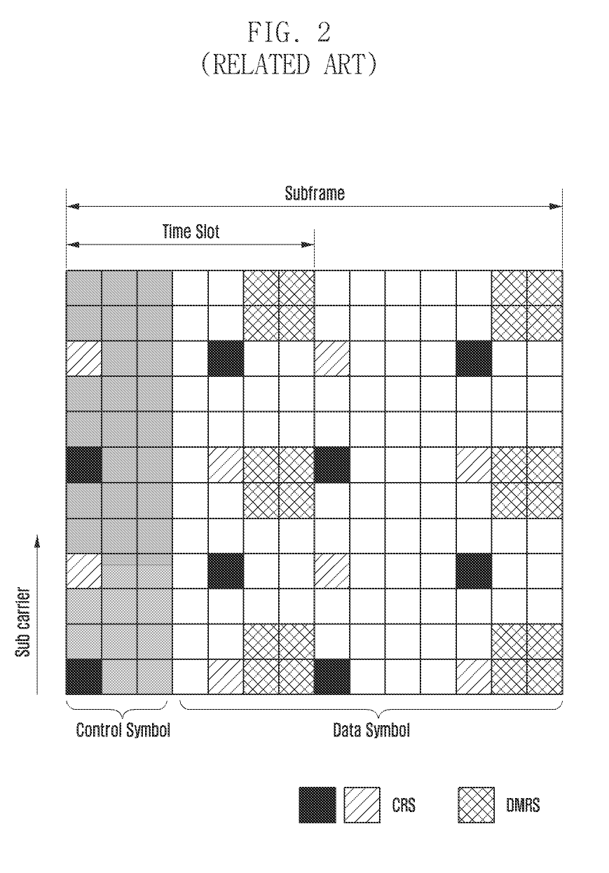

FIG. 3 is a schematic diagram illustrating a division of enhanced Resource Element Group (eREG) according to the related art.

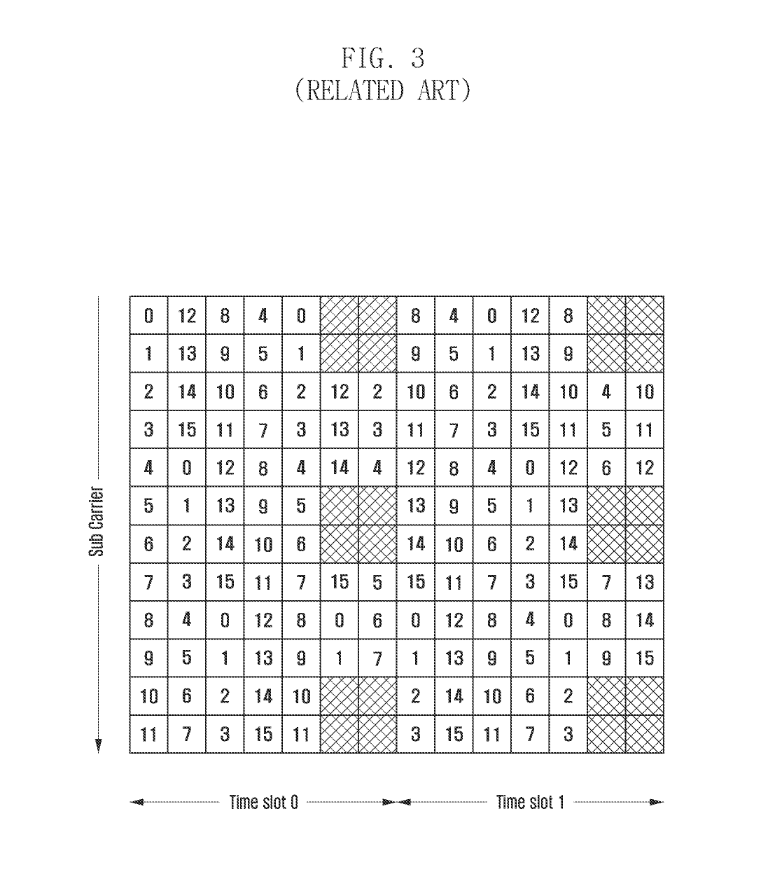

FIG. 4 is a schematic flowchart illustrating a procedure according to an embodiment of the present disclosure.

FIG. 5 is a schematic diagram illustrating a first configuration of an enhanced Physical Downlink Control CHannel (ePHCCH) set used for an enhanced Physical Hybrid Automatic Repeat Request (HARQ) Indicator CHannel (ePHICH) according to an embodiment of the present disclosure.

FIG. 6 is a schematic diagram illustrating a second configuration of an ePHCCH set used for an ePHICH according to an embodiment of the present disclosure.

FIG. 7 is a schematic diagram illustrating a third configuration of an ePHCCH set used for an ePHICH according to an embodiment of the present disclosure.

FIG. 8 is a schematic diagram illustrating a fourth configuration of an ePHCCH set used for an ePHICH according to an embodiment of the present disclosure.

FIG. 9 is a schematic diagram illustrating a structure of a base station according to an embodiment of the present disclosure.

FIG. 10 is a schematic diagram illustrating a structure of a terminal device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

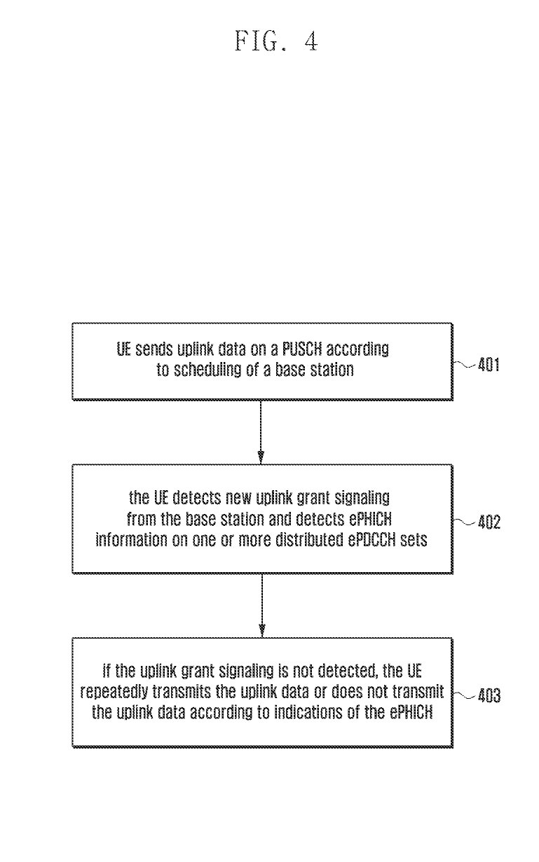

FIG. 4 is a schematic flowchart illustrating a procedure of synchronous Hybrid Automatic Repeat Request (HARQ) transmission for a Physical Uplink Shared CHannel (PUSCH) according to an embodiment of the present disclosure. FIG. 4 is discussed below in the context of systems transmitting enhanced Physical Downlink Control CHannels (ePDCCHs) and enhanced Physical Control Format Indicator CHannel (ePHICHs) based on DeModulation Reference Signals (DMRSs). The procedure includes the following operations.

In operation 401, User Equipment (UE) sends uplink data on a PUSCH according to scheduling of a base station. The uplink data may be scheduled dynamically by using uplink grant signaling, or the uplink data transmission may be retransmission of uplink data transmitted formerly after triggered by an ePHICH, or the uplink data may be transmitted on uplink channel resources assigned by Semi-Persistent Scheduling (SPS).

In operation 402, according to a synchronous HARQ timing relationship, the UE detects new uplink grant signaling and ePHICH information from the base station. The ePHICH resources are mapped to at least parts of time frequency resources of one or more distributed ePDCCH sets.

In operation 403, if the uplink grant signaling is not detected, the UE works according to indications of the ePHICH. When the ePHICH indicates Negative ACKnowledgement (NACK), the UE repeatedly transmits the uplink data according to the timing relationship of synchronous HARQ; when the ePHICH indicates ACKnowledgement (ACK), the UE does not transmit the uplink data.

In operation 402, the mapped ePHICH resources are determined according to uplink grant signaling in a same synchronous HARQ procedure. A relate-art method of the LTE system may be used, for dynamic uplink data transmission, the ePHICH resources are determined according to last uplink grant signaling in the same synchronous HARQ procedure; for SPS services, the ePHICH resources are determined according to an original uplink grant signaling triggering the SPS transmission. For ePDCCH transmission, the system may configure multiple ePDCCH sets, and each ePDCCH is specially used to carry a distributed ePDCCH or a localized ePDCCH. For example, the system may be limited to configure two ePDCCH sets at most for carrying the ePDCCHs. In the two ePDCCH sets, one is used for the distributed ePDCCH and the other is used for the localized ePDCCH; or the two ePDCCH sets are both used for the distributed ePDCCHs; or the two ePDCCH sets both used for the localized ePDCCHs. When the base station configures the UE to detect the uplink grant signaling on multiple ePDCCH sets, all the uplink grant signaling sent on the multiple ePDCCH sets need mapped ePHICH resources.

With regard to the system based on DMRS transmission, each ePHICH resource needs to be mapped to multiple PRB pairs, so as to improve frequency division gain. In this way, a design principle of a set of multiple PRB pairs mapping the ePHICH resources is the same as that of related-art distributed ePDCCHs. Specifically, the DMRS on each PRB pair of the ePDCCH set used for the ePHICH is shared. For example, the DMRSs of two ports are sent on each PRB pair, and the DMRSs of the two ports are shared by the ePHICH resources multiplexed on the ePDCCH set. Therefore, the set of the multiple PRB pairs mapping the ePHICH resources may be referred to as a distributed ePDCCH set. In fact, the distributed ePDCCH and ePHICH may be multiplexed on the distributed ePDCCH set. For the purpose of improving reliability by using the frequency division, an ePHICH needs to be mapped to the PRB pairs on the ePDCCH set as many as possible. As described above, the ePHICH is transmitted via mapped to the distributed ePDCCH set, this ePDCCH set may be merely used for the ePHICH transmission, or may use for the ePDCCH and ePHICH at the same time.

For the ePDCCH set used for the ePHICH, the base station may configure an initial value of a random number generator user for generating a DMRS sequence according to a virtual cell indication X. For example, the initial value is:

cᵢₙᵢₜ=(└nₛ/2┘+1)·(2X+1)·2¹⁶+n_{SCID}

Herein, nₛ is an index of a time slot of the ePHICH, and n_{SCID} is equal to 2. When the distributed ePDCCH and ePHICH are both on the distributed ePDCCH set used for the ePHICH, preferably, the base station needs to ensure that the same virtual cell indication X are configured for the UE detecting the ePDCCH on the ePDCCH set and the UE detecting the ePHICH on the ePDCCH set, so that the ePDCCH and the ePHICH on the ePDCCH set use the same DMRS signals.

The embodiments of the present disclosure provide several methods for configuring the ePDCCH set used for the ePHICH, and the methods will be described hereinafter.

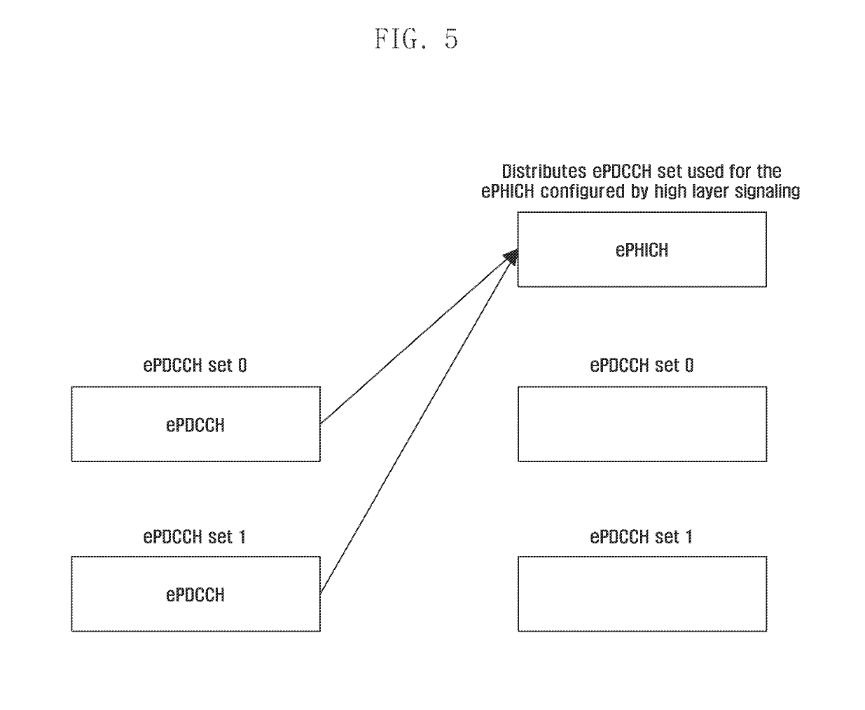

FIG. 5 is a schematic diagram illustrating a first configuration of an ePHCCH set used for an ePHICH according to an embodiment of the present disclosure.

Referring to FIG. 5, in the first method for configuring the ePDCCH set used for the ePHICH, parameters of the ePDCCH set used for the ePHICH are configured for the UE via high layer signaling (e.g., Radio Resource Control (RRC) signaling), which includes the virtual cell indication X used for generating the DMRS sequence, etc. The high layer signaling may configure a ePDCCH set used for the ePHICH, so that uplink grant signaling sent on each ePDCCH set in which the ePDCCH is detected by the UE are all mapped to the ePHICHs in the ePDCCH set used for the ePHICH. Or, the high layer signaling may configure multiple ePDCCH sets used for the ePHICH. In this way, uplink grant signaling sent on each ePDCCH set in which the ePDCCH is detected by the UE are mapped to the ePHICHs in the ePDCCH sets used for the ePHICH, it is not limited that all the uplink grant signaling in the ePDCCH set for sending the ePDCCH are mapped to the ePHICH in the same ePDCCH set used for the ePHICH configured by the high layer. Specially, the high layer signaling may respectively configure a ePDCCH set used for the ePHICH for each ePDCCH set in which the ePDCCH is detected by the UE, that is, the uplink grant signaling in the ePDCCH set only maps ePHICH resources in the corresponding ePDCCH set used for the ePHICH. The multiple ePDCCH sets used for the ePHICH configured for the UE by the high layer signaling may be the same or different, which is not limited in the present disclosure. The ePDCCH set used for the ePHICH configured for the UE by the high layer signaling may be different from any configured ePDCCH set in which the ePDCCH is detected by the UE, i.e., the ePDCCH set is merely used for the ePHICH transmission; or may be completely the same as a distributed ePDCCH set in which the ePDCCH is detected by the UE, i.e., the ePDCCH set is used for the transmission of both the ePDCCH and ePHICH. For the UE, the ePDCCH set used for the ePHICH is configured by the high layer signaling, so that all of the UEs in the cell may be configured with the same ePDCCH set used for the ePHICH, and thus the ePHICH resources are assigned in only one distributed ePDCCH set; or the same ePDCCH set used for the ePHICH may be configured for multiple UEs in the cell, so that multiple ePDCCH sets used for the ePHICH may be configured in the cell and multiple UEs share the ePHICH resources in the ePDCCH set used for the ePHICH; or different ePDCCH sets used for the ePHICH may be configured for different UEs, so that the ePHICH resources in the cell may be distributed to multiple ePDCCH sets. By using a method in which the high layer signaling is used, the base station may freely configure the ePDCCH set used for the ePHICH, which is not limited in the present disclosure.

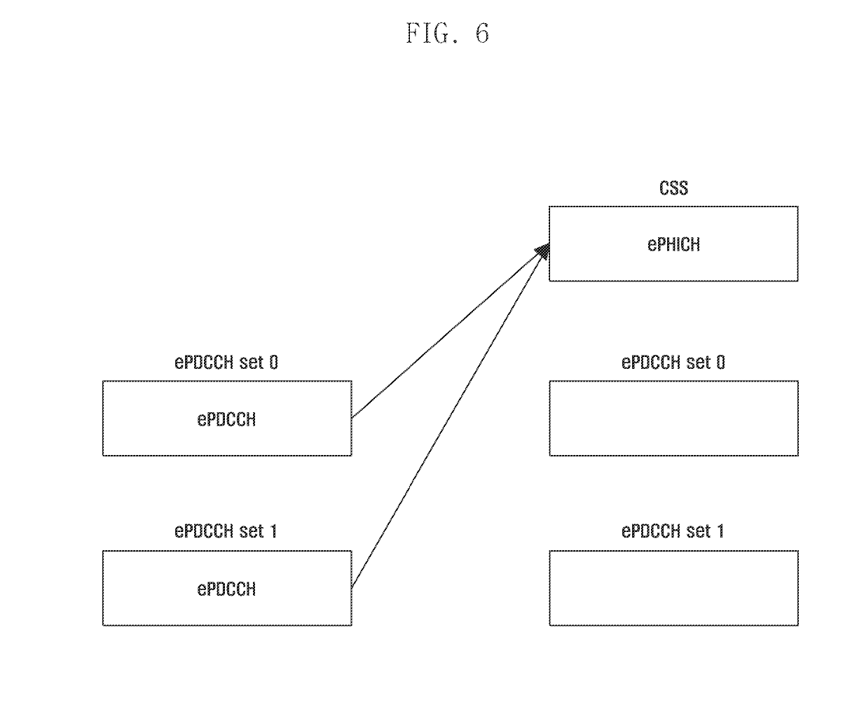

FIG. 6 is a schematic diagram illustrating a second configuration of an ePHCCH set used for an ePHICH according to an embodiment of the present disclosure.

Referring to FIG. 6, a second method for configuring the ePDCCH set used for the ePHICH is provided. If a distributed ePDCCH set used for carrying Common Search Space (CSS) is configured for the UE, the ePHICHs may be mapped to the distributed ePDCCH set used for the CSS for the UE. The uplink grant signaling sent on the multiple ePDCCH sets in which the ePDCCH is detected by the UE are all mapped to the ePHICHs in the distributed ePDCCH sets used for the CSS, so that no extra signaling cost is needed for configuring the ePDCCH set used for the ePHICH. The ePDCCH and ePHICH of the CSS may be sent by using the same DMRS port. The DMRS sequence of the CSS is generally generated by using a cell-specific indication, the DMRS sequence of the ePHICH in the CSS needs to be generated based on the same cell-specific indication. In this way, when two ePDCCH sets of the UE are both configured as the localized ePDCCH sets, the ePHICH resources of the UE are able to be obtained. In fact, according to the design of the CSS, if the CSS only can be mapped to merely one distributed ePDCCH set, the ePDCCH set used for the ePHICH is uniquely determined according to the second method. If the CSS is mapped to multiple distributed ePDCCH sets, one of the ePDCCH sets used for the CSS may carry the ePHICH; or the multiple ePDCCH sets used for the CSS may carry the ePHICHs.

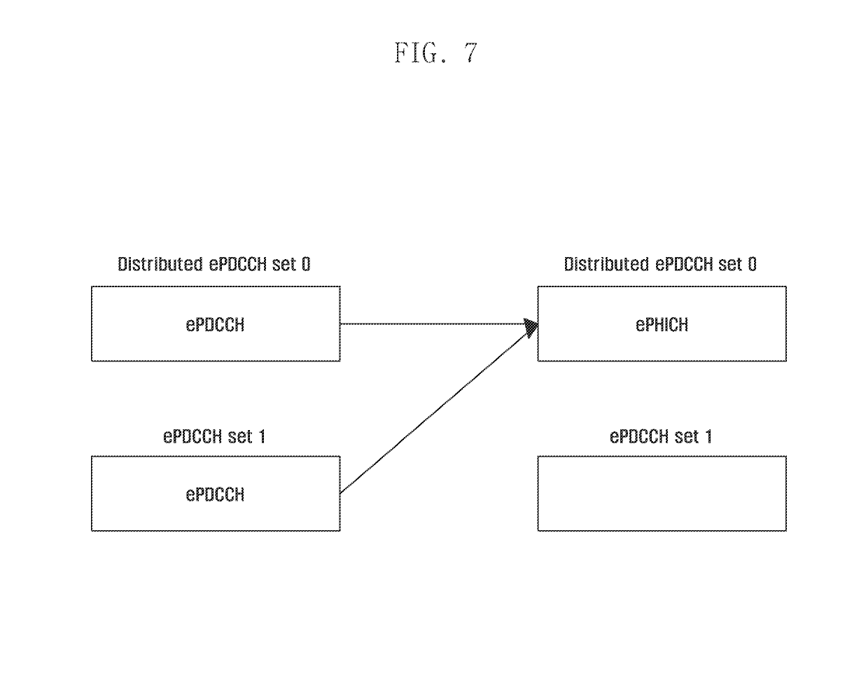

FIG. 7 is a schematic diagram illustrating a third configuration of an ePHCCH set used for an ePHICH according to an embodiment of the present disclosure.

Referring to FIG. 7, a third method for configuring the ePDCCH set used for the ePHICH is provided. When the UE is configured with at least one distributed ePDCCH set in which the ePDCCH is detected, the ePHICH may be mapped for the UE to one distributed ePDCCH set in which the ePDCCH is detected by the UE. The uplink grant signaling sent on the multiple ePDCCH sets in which the ePDCCH is detected by the UE are all mapped to the ePHICHs in the ePDCCH set used for the ePHICH. For example, if at most two ePDCCH sets used for detecting the ePDCCH are configured for the UE, one bit information may be used to indicate the ePDCCH set that is used for carrying the ePHICH; or the first ePDCCH set used for the ePDCCH transmission for the UE is fixedly configured as a distributed ePDCCH set, and the ePHICH is mapped to the ePDCCH, so that no extra signaling cost is needed. For multiple UEs in the cell, the ePHICH resources may be assigned to one distributed ePDCCH set, i.e., at least a same distributed ePDCCH set is configured for the UEs; or the ePHICH resources in the cell may be distributed to multiple ePDCCH sets. For example, the ePDCCH sets configured for the UEs may be totally different, which is not limited in the present disclosure. In this method, when the UE is configured with only a localized ePDCCH set, the UE does not support the transmission of the ePHICH, that is, each synchronous HARQ transmission of the uplink data needs to be trigged by the uplink grant signaling. After the UE transmits the uplink data, if the UE does not detect a new uplink grant signaling of the same HARQ procedure, the UE reports an ACK to a high layer without canceling the uplink data packet in a buffer. Or if the UE is configured with only the localized ePDCCH set, the ePHICH resources may be mapped according to the method shown in FIGS. 5 and 6.

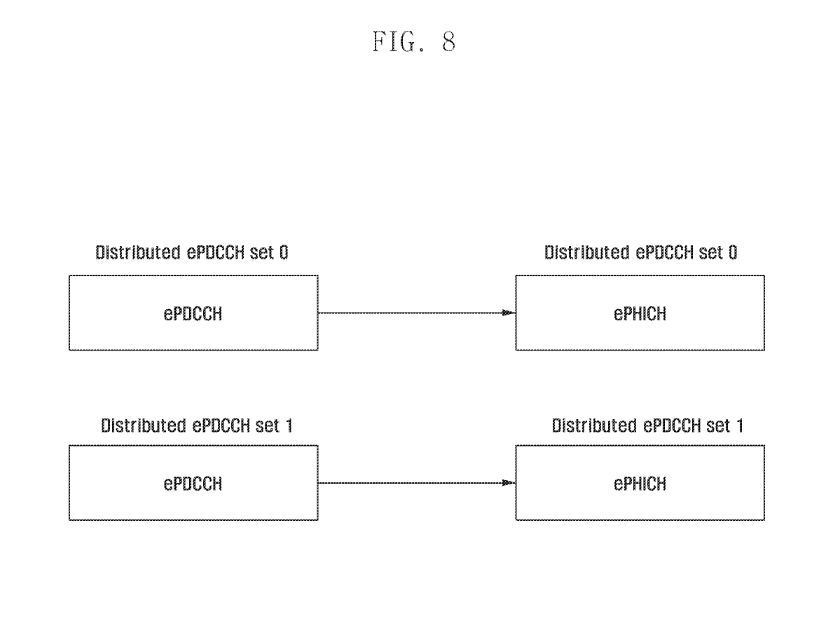

FIG. 8 is a schematic diagram illustrating a fourth configuration of an ePHCCH set used for an ePHICH according to an embodiment of the present disclosure.

Referring to FIG. 8, a fourth method for configuring the ePDCCH set used for the ePHICH is provided. When the UE is configured with more than one distributed ePDCCH set in which the ePDCCH is detected, for each distributed ePDCCH set in which the ePDCCH is detected, for the uplink grant signaling on the ePDCCH set, according to the synchronous HARQ timing relationship, on a subframe on an ePHICH timing location, the ePHICH is mapped to the same distributed ePDCCH set. By using this method, each distributed ePDCCH set carries both the ePDCCH and the ePHICH; and one ePDCCH set only carries the sent ePHICH of the uplink grant signaling corresponding to this ePDCCH set. Or when the UE is configured with more than one distributed ePDCCH set in which the ePDCCH is detected, the ePHICH is assigned to the multiple ePDCCH sets; for the uplink grant signaling in each distributed ePDCCH set in which the ePDCCH is detected, according to the synchronous HARQ timing relationship, on a subframe on the ePHICH timing location, the ePHICH could be mapped to the multiple distributed ePDCCH sets. If there is a localized ePDCCH set configured for the UE, for the uplink grant signaling sent on the localized ePDCCH set, the corresponding ePHICH may be mapped to one distributed ePDCCH set or may be mapped to the multiple distributed ePDCCH sets. In this method, each UE configured with multiple distributed ePDCCH sets are assigned with the ePHICHs on the multiple ePDCCH sets, for the whole cell, the ePHICH resources are distributed to all the distributed ePDCCH sets. Similarly with FIG. 7, when the UE is configured with only a localized ePDCCH set, the ePHICH transmission is not supported by the UE, that is, each synchronous HARQ transmission for the uplink data needs to be triggered by the uplink grant signaling. After the UE transmits the uplink data, if the UE does not detect a new uplink grant signaling of the same HARQ procedure, the UE reports an ACK to a high layer without canceling the uplink data packet in a buffer. Or if the UE is configured with only the localized ePDCCH set, the ePHICH resources may be mapped according to the method shown in FIGS. 5 and 6.

On the ePDCCH set used for the ePHICH, the time frequency resources occupied by the ePHICH may be configured semi-statically or dynamically. When the ePHICH is configured semi-statically, other REs except the REs occupied by the ePHICH on the ePDCCH set can be used for transmitting the ePDCCH; when the ePHICH is configured dynamically, all the eCCE not used for the ePHICH on the ePDCCH set may be used for transmitting the ePDCCH. Two methods for assigning the ePHICH time frequency resources are described hereinafter.

In the first method, the ePHICH resources may be obtained via punching the eREG on the PRB pair, that is, the number of REs could be used for the ePDCCH transmission in each eREG is reduced. The UE should to know the number of REs used for the ePHICH on the ePDCCH set, so as to correctly detect the ePDCCH on the RE set. Hence, this method is applied to semi-statical configuration of ePHICH. Specifically, similar with the related-art PHICH transmission, the system may semi-statically configure the number of the ePHICH resources on the ePDCCH set, so as to obtain the REs occupied by the ePHICH and the number of the REs, which may be determined via configuring the number of the ePHICH groups. In this method, the ePHICH resources may be assigned to only one distributed ePDCCH set, and thus the size of the eCCE on the distributed ePDCCH set including the ePHICH is different from that of the distributed ePDCCH set without the ePHICH, which causes differences of link performances between the distributed ePDCCHs; or the ePHICH resources may be assigned averagely to the multiple distributed ePDCCH sets, so that each of the distributed ePDCCH set in the cell has the eCCE of the same size, which make the distributed ePDCCHs have average link performances.

In the second method, the ePHICH resources may occupy one or more complete eCCEs. In this way, the transmission of the ePHICHs does not affect link performances of other eCCEs used for the ePDCCH on the ePDCCH set. Since the number of the eCCEs obtained via dividing the ePDCCH set is unchanged, the number of eCCEs used for the ePDCCH transmission is reduced. In this method, the ePHICH resources may be assigned to one distributed ePDCCH set, so that the number of eCCEs for transmitting the ePDCCH on the distributed ePDCCH set including the ePHICH is less than that of the distributed ePDCCH set without the ePHICH; or the ePHICH resources may be assigned averagely to the multiple distributed ePDCCH sets, so that the number of eCCEs used for transmitting the ePDCCH on each distributed ePDCCH set in the cell is identical with each other.

The second method for assigning the ePHICH time frequency resources may be applied for semi-statically configuring the ePHICH. Similar with the PHICH transmission of the related-art system, the system may semi-statically configure the number of the ePHICH resources on the ePDCCH set. The system may semi-statically configure the number of ePHICH groups, and obtain the number of the eCCEs occupied by the ePHICHs according to the number of the configured ePHICH groups. Because the number of the usable REs of the eCCEs on different subframes may be different, the number of needed eCCEs may be calculated for different subframes or a group of subframes according to the number of the configured ePHICH groups based on the number of the REs of the eCCEs; or each subframe may be configured with the same number of the eCCEs for the ePHICH. For example, the system may semi-statically configure the number of the eCCEs for the ePHICH, and calculate the number of supported ePHICH groups. The number of eCCEs for the ePHICH transmission may be configured for different subframes or a group of subframes respectively; or each subframe may be configured with the same number of the eCCEs for the ePHICH.

The second method for assigning the ePHICH time frequency resources may be applied for dynamically configuring the ePHICH. That is, when UE-specific ePDCCH Search Space (USS) is configured on the distributed ePDCCH set, it is allowed that the eCCEs occupied by the ePDCCHs in the USS may be overlaid with the eCCEs which may be used for the ePHICHs. In this way, if one eCCE does not carry any ePHICH currently, the base station scheduler may make the eCCE transmit the ePDCCH of the UE dynamically, so as to improve a resource utilization rate. For the method in which the ePDCCH and the ePHICH are dynamically multiplexed, the system may still semi-statically configure the maximum number of the ePHICH resources on the ePDCCH set, which may be implemented via configuring the maximum number of the eCCEs used for the ePHICH; or may be implemented via configuring the maximum number of the ePHICH groups. The semi-statically configuring of the maximum number of the ePHICH resources includes determining the assigned ePHICH resources mapped by the UE according to the uplink grant signaling, and it is not limited that a corresponding number of the time frequency resources should be reserved and not used for transmitting the ePDCCHs. Specially, the system may not send any information of the maximum number of the ePHICH resources, but obtain information of the maximum number of the ePHICH resources implicitly. For example, the needed maximum number of the ePHICH resources may be obtained according to the number of the PRBs in the uplink bandwidth and requirements of uplink Multi-User-Multiple-Input and Multiple-Output MU-MIMO, etc. For example, according requirements of the related-art LTE system, the uplink bandwidth is recorded as N_{RB}^{UL}, the maximum value of the number of the ePHICH resources to be reserved is 2N_{RB}^{UL}, the maximum number of the eCCEs may be obtained according to the maximum value of the number of the ePHICH resources to be supported; or it may be defined implicitly that the maximum number of the eCCEs used for the ePHICH is equal to a fixed value, e.g., it may be defined that the number of the eCCEs used for transmitting the ePHICH is 8 for each ePDCCH set used for transmitting the ePHICH.

For uplink downlink configuration 0 of the Time Division Duplex (TDD), according to the method of the related-art LTE system, the ePHICH resources assigned for subframes 0 and 5 should be twice as that assigned for other subframes. In the method in which the ePHICHs are configured dynamically, the time frequency resources occupied by the two ePHICH areas (corresponding to the I_{PHICH} in the formula) may be assigned alternately. For example, on one ePDCCH set used for the ePHICH, the time frequency resources may be assigned alternately for the two ePHICH areas by using the eCCE as a unit, the first ePHICH area (I_{PHICH}=0) occupies the eCCEs with the even index, and the second ePHICH area (I_{PHICH}=1) occupies the eCCEs with the odd index. Or if one eCCE can carry multiple ePHICH groups, on one ePDCCH set used for the ePHICH, the time frequency resources may be assigned alternately for the two ePHICH areas by using the ePHICH group as a unit, the first ePHICH area (I_{PHICH}=0) occupies the ePHICH groups with the even index, and the second ePHICH area (I_{PHICH}=1) occupies the ePHICH groups with the odd index. Or on one ePDCCH set used for the ePHICH, the time frequency resources may be assigned alternately for the two ePHICH areas by using the ePHICH resource as a unit, the first ePHICH area (I_{PHICH}=0) occupies the ePHICH resources with the even index, and the second ePHICH area (I_{PHICH}=1) occupies the ePHICH resources with the odd index.

Similar to the PHICH transmission of the related-art system, for the mapping of the ePHICH resources, multiple ePHICH groups may be defined, and each ePHICH group includes multiple ePHICH resources. Each ePHICH resource is identified by using an index pair (n_{ePHICH}^{group},n_{ePHICH}^{seq}), n_{ePHICH}^{group} is the number of the ePHICH group, and n_{ePHICH}^{seq} is an index of the ePHICH resource in the ePHICH group.

For example, if the ePHICH resources are multiplexed in the ePHICH group by using orthogonal sequence, the n_{ePHICH}^{seq} is the index of the orthogonal sequence.

For example, if the ePHICH is obtained by punching the eREG on the PRB pair, according to the related-art method for transmitting the PHICH, each ePHICH group includes 8 ePHICH resources and the ePHICH resources are identified by using an orthogonal sequence.

For example, if the ePHICHs occupied one or more complete eCCEs, the related-art method for transmitting the PHICH may also be used, and each ePHICH group includes 8 ePHICHs. Or the ePHICH resources carried in one eCCE are taken as one ePHICH group, indication information n_{DMRS} of an uplink reference signal in the uplink grant signaling may be used for selecting the ePHICH group, i.e., selecting the eCCE, so that the ePHICHs are gathered into some eCCEs, the other eCCEs may be used for transmitting the ePDCCH. Or, the ePHICH resources carried in one eCCE are divided into N (larger than 1) ePHICH groups. Or the ePHICH resources carried in multiple eCCEs are divided into multiple ePHICH groups. In the above several methods for dividing the PHICH groups, n_{DMRS} in the uplink grant signaling may be used to control the ePHICHs practically carried by the eCCE, and other eCCEs may be dynamically used for transmitting the ePDCCH.

For the uplink synchronous HARQ transmission of the UE, the method for mapping the ePHICH resources used by the UE is described. First, the number of configured ePHICH groups may be obtained according to a high layer signaling (e.g., RRC signaling or a broadcast message), or information of the maximum number of the ePHICH groups may be obtained implicitly. In the method, the number of the ePHICH groups may be the number of the ePHICH groups on an ePDCCH set used for the ePHICH. In this way, if the base station uses the ePHICH resources on N distributed ePDCCH sets, the number of ePHICH groups practically supported by the base station is N times of the number of ePHICH groups of an ePDCCH set used for the ePHICH configured by the high layer signaling. In addition, the number of ePHICH groups indicated by the high layer signaling may be the sum of the ePHICH groups on the ePDCCH sets of the ePHICHs of the base station. For one UE, if the ePHICHs are only mapping to one distributed ePDCCH set, the UE can only use the ePHICHs on this distributed ePDCCH set; if the ePHICHs of the UE are mapping to M (less than N, e.g., M is equal to 2) distributed ePDCCH sets, the UE can use the ePHICHs on the M distributed ePDCCH sets.

Afterwards, the ePHICH resources may be mapped according to the minimum PRB index of the PUSCH and the n_{DMRS} in the uplink grant signaling. When the ePHICHs of the UE need to be mapped to one distributed ePDCCH set, the PHICH resources occupied by the UE may be:

n_{ePHICH}^{group}=(I_{PRB}_{_{—}}_{RA}^{lowest}^{_{—}}^{index}+n_{DMRS})mod N_{ePHICH}^{group}+I_{PHICH}N_{ePHICH}^{group}

n_{ePHICH}^{seq}=(└I_{PRB}_{_{—}}_{RA}^{lowest}^{_{—}}^{index}/N_{ePHICH}^{group}┘+n_{DMRS})mod N_{G}^{ePHICH}

Herein, n_{DMRS} is indication information of the uplink reference signal;

N_{G}^{PHICH} is the number of the ePHICH resources in one ePHICH group;

I_{PRB}_{_{—}}_{RA}^{lowest}^{_{—index}} is the minimum PRB index in the first time slot of the PUSCH;

N_{PHICH}^{group} is the number of the configured ePHICH groups;

$${I}_{PHICH} = \{ \begin{matrix}1 & \begin{matrix}PUSCH transmission in the subframe 4 and 9 \\ for uplink / downlink configuration 0 of the TDD\end{matrix} \\ 0 & other .\end{matrix} \\ {n}_{ePHICH}^{group} = ( {I}_{PRB\_RA}^{lowest\_index} + 8 {n}_{set} + {n}_{DMRS} ) mod {N}_{ePHICH}^{group} + {I}_{PHICH} {N}_{ePHICH}^{group} \\ {n}_{ePHICH}^{seq} = ( ⌊ {I}_{PRB\_RA}^{lowest\_index} / {N}_{ePHICH}^{group} ⌋ + 8 {n}_{set} + {n}_{DMRS} ) mod {N}_{G}^{ePHICH} .$$

When the ePHICHs needs to be mapped to the same distributed ePDCCH set for the uplink grant signaling sent by the UE on the multiple ePDCCH sets, for the uplink grant signaling on each ePDCCH set, the ePHICH resources may be mapped according to the above formula repeatedly. Or when the PHICH mapping are performed for the uplink grant signaling sent by the UE on the multiple ePDCCH sets, different PHICH resource mapping methods may be used for different ePDCCH sets, so as to reduce the probability of collisions of the PHICH resources and increase scheduling flexibility. For example, different offsets may be added to the different ePDCCH sets. For example, in the related-art method of PHICH mapping, n_{DMRS} may adjust the ePHICH resources mapping for one uplink PRB index, the value range of n_{DMRS} is 0˜7. Therefore, based on the n_{DMRS}, the mapped ePHICH resources may be adjusted between different ePDCCH sets, and an extra offset may be 8nₛₑₜ, nₛₑₜ is the index of each ePDCCH set in which the ePDCCH is detected by the UE, i.e., nₛₑₜ=0, 1, . . . . In this way, the ePHICH resources mapped for the uplink grant signaling in the nₛₑₜth ePDCCH set of the UE is:

n_{ePHICH}^{group}=(I_{PRB}_{_{—}}_{RA}^{lowest}^{_{—}}^{index}+8nₛₑₜ+n_{DMRS})mod N_{ePHICH}^{group}+I_{PHICH}N_{ePHICH}^{group}

n_{ePHICH}^{seq}=(└I_{PRB}_{_{—}}_{RA}^{lowest}^{_{—}}^{index}/N_{ePHICH}^{group}┘+8nₛₑₜ+n_{DMRS})mod N_{G}^{ePHICH}

If the ePHICH resources are assigned to M ePDCCH sets of the UE, N_{PHICH}^{group} may be configured as the sum of the ePHICH groups in the M ePDCCH sets, and the above formula may be used to map the ePHICH resources. Then, the ePHICH resources mapped for the uplink grant signaling in one ePDCCH set of the UE are distributed to multiple ePDCCH sets used for the ePHICH.

In another method for mapping the ePHICH resources for the UE, the ePHICH resources are mapped according to the minimum eCCE index n_{eCCE} occupied by the uplink grant signaling and the n_{DMRS} in the uplink grant signaling. For example, when the ePHICHs of the UE are to be mapped to one distributed ePDCCH set, I_{PRB}_{_{—}}_{RA}^{lowest}^{_{—}}^{index} in the above formula is replaced by n_{eCCE}, and a corresponding method for mapping the ePHICH resources is:

n_{ePHICH}^{group}=(n_{eCCE}+n_{DMRS})mod N_{ePHICH}^{group}+I_{PHICH}N_{ePHICH}^{group}

n_{ePHICH}^{seq}=(└n_{eCCE}/N_{ePHICH}^{group}┘+n_{DMRS})mod N_{G}^{ePHICH}

When the PHICHs needs to be mapped to the same distributed ePDCCH set for the uplink grant signaling sent by the UE on the multiple ePDCCH sets, for the uplink grant signaling on each ePDCCH set, the ePHICH resources may be mapped according to the above formula repeatedly. Or when the PHICH mapping are performed for the uplink grant signaling sent by the UE on the multiple ePDCCH sets, different PHICH resource mapping methods may be used for different ePDCCH sets, so as to reduce the probability of collisions of the PHICH resources and increase scheduling flexibility. For example, different offsets may be added to the different ePDCCH sets. For example, the eCCEs on the multiple ePDCCH sets in which the ePDCCH are detected by the UE may be numbered, and the above formula may be used. When mapping the ePHICH resources, the number of the eCCE indexes n_{eCCE} in the nₛₑₜth ePDCCH set may be

$$( {\sum }_{n = 0}^{{n}_{set} - 1} {N}_{eCCE}^{( n )} ) + {n}_{eCCE} ,$$

N_{eCCE}⁽ⁿ⁾ is the total number of the eCCEs divided from the n^{th} ePDCCH set. In this way, the ePHICH resources mapped for the eCCE index n_{eCCE} in the nₛₑₜth ePDCCH set of the UE is:

$${n}_{ePHICH}^{group} = ( ( {\sum }_{n = 0}^{{n}_{set} - 1} {N}_{eCCE}^{( n )} ) + {n}_{eCCE} + {n}_{DMRS} ) mod {N}_{ePHICH}^{group} + {I}_{PHICH} {N}_{ePHICH}^{group}$$

$${n}_{ePHICH}^{seq} = ( ⌊ ( ( {\sum }_{n = 0}^{{n}_{set} - 1} {N}_{eCCE}^{( n )} ) + {n}_{eCCE} ) / {N}_{ePHICH}^{group} ⌋ + {n}_{DMRS} ) mod {N}_{G}^{ePHICH}$$

If the ePHICH resources are assigned on M ePDCCH sets of the UE, N_{PHICH}^{group} may be configured as the sum of the ePHICH groups in the M ePDCCH sets, and the above formula may be used to assign the ePHICH resources. Then, the ePHICH resources corresponding to the uplink grant signaling in one ePDCCH set of the UE are distributed to multiple ePDCCH sets used for the ePHICH.

Or, the ePHICH resources may be mapped according to the minimum PRB index of the PUSCH, the minimum eCCE index n_{eCCE} occupied by the uplink grant signaling and the n_{DMRS} in the uplink grant signaling. For example, when the ePHICHs of the UE are to be mapped to one distributed ePDCCH set, I_{PRB}_{_{—}}_{RA}^{lowest}^{_{—}}^{index} in the above formula is replaced by I_{PRB}_{_{—}}_{RA}^{lowest}^{_{—}}^{index}+n_{eCCE}, and a corresponding method for mapping the ePHICH resources is:

n_{ePHICH}^{group}=(I_{PRB}_{_{—}}_{RA}^{lowest}^{_{—}}^{index}+n_{eCCE}+n_{DMRS})mod N_{ePHICH}^{group}+I_{PHICH}N_{ePHICH}^{group}

n_{ePHICH}^{seq}=(└(I_{PRB}_{_{—}}_{RA}^{lowest}^{_{—}}^{index}+n_{eCCE})/N_{ePHICH}^{group}┘+n_{DMRS})mod 2N_{G}^{ePHICH}

When the PHICHs need to be mapped to the same distributed ePDCCH set for the uplink grant signaling sent by the UE on the multiple ePDCCH sets, for the uplink grant signaling on each ePDCCH set, the ePHICH resources may be mapped according to the above formula repeatedly. Or when the PHICH mapping are performed for the uplink grant signaling sent by the UE on the multiple ePDCCH sets, different PHICH resource mapping method may be used for different ePDCCH sets, so as to reduce the probability of collisions of the PHICH resources and increase scheduling flexibility. For example, the ePHICH resources mapped for the eCCE index n_{eCCE} in the nₛₑₜth ePDCCH set of the UE is:

$${n}_{ePHICH}^{group} = ( {I}_{PRB\_RA}^{lowest\_index} + ( {\sum }_{n = 0}^{{n}_{set} - 1} {N}_{eCCE}^{( n )} ) + {n}_{eCCE} + {n}_{DMRS} ) mod {N}_{ePHICH}^{group} + {I}_{PHICH} {N}_{ePHICH}^{group}$$

$${n}_{ePHICH}^{seq} = ( ⌊ ( {I}_{PRB\_RA}^{lowest\_index} + ( {\sum }_{n = 0}^{{n}_{set} - 1} {N}_{eCCE}^{( n )} ) + {n}_{eCCE} ) / {N}_{ePHICH}^{group} ⌋ + {n}_{DMRS} ) mod {N}_{G}^{ePHICH} .$$

If the ePHICH resources are mapped to M ePDCCH sets of the UE, N_{PHICH}^{group} may be configured as the sum of the ePHICH groups in the M ePDCCH sets, and the above formula may be used for mapping the ePHICH resources. Then, the ePHICH resources corresponding to the uplink grant signaling in one ePDCCH set of the UE are distributed to multiple ePDCCH sets used for the ePHICH.

Corresponding to the above methods, the embodiments of the present disclosure provides apparatus respectively.

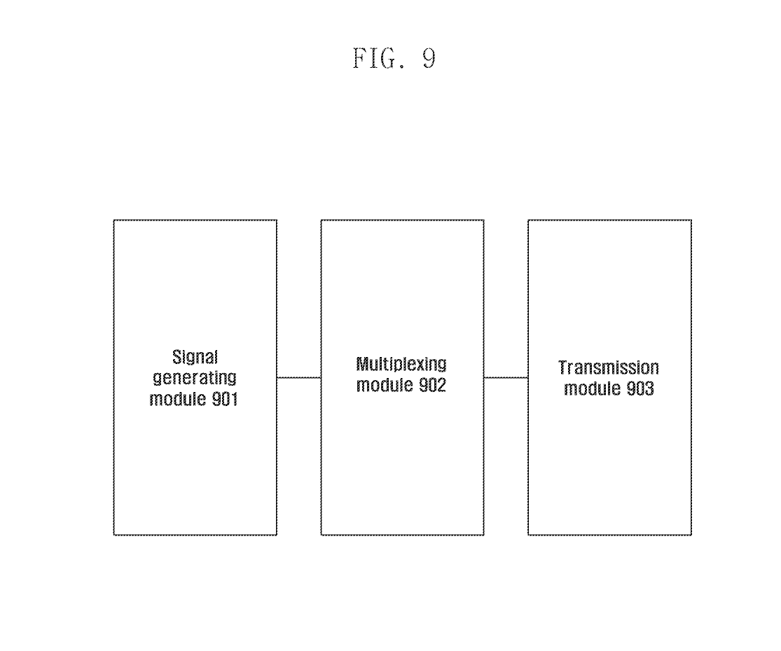

FIG. 9 is a schematic diagram illustrating a structure of a base station sending an ePHICH according to an embodiment of the present disclosure.

Referring to FIG. 9, the apparatus includes a signal generating module 901, a multiplexing module 902, and a transmission module 903.

The signal generating module 901 is configured to generate ePHICH signals to be sent on ePHICH resources.

The multiplexing module 902 is configured to map the ePHICH signals to assigned time frequency resources of one or more distributed ePDCCH sets used for sending the ePHICH.

The transmission module 903 is configured to send the mapped ePHICH signal.

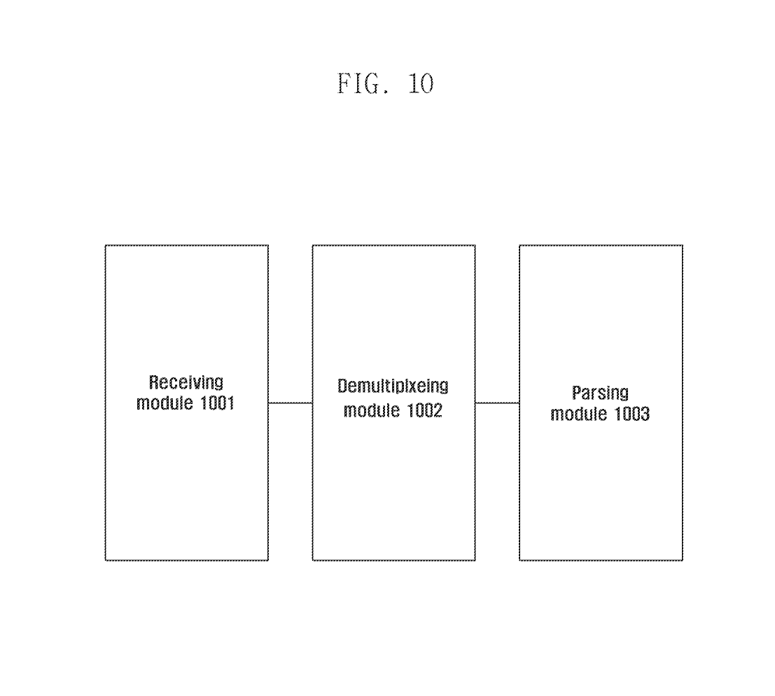

FIG. 10 is a schematic diagram illustrating a structure of a UE device receiving an ePHICH according to an embodiment of the present disclosure.

Referring to FIG. 10, the apparatus includes a receiving module 1001, a demultiplexing module 1002 and a parsing module 1003.

The receiving module 1001 is configured to detect and receive a signal.

The demultiplexing module 1002 is configured to demultiplex the ePHICH signal from time frequency resources of a corresponding distributed ePDCCH set.

The parsing module 1003 is configured to parse the ePHICH signal and to obtain HARQ-ACK information for uplink data.

By using the method and apparatus of the present disclosure, the ePHICH resources are effectively mapped for the uplink data transmission of the UE, and impact of the mapped ePHICH on the ePDCCH is reduced.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for transmitting Hybrid Automatic Repeat Request (HARQ) indication information, the method comprising:
transmitting, by a User Equipment (UE), uplink data on a Physical Uplink Shared CHannel (PUSCH) according to scheduling of a base station;
according to a synchronous HARQ timing relationship, detecting, by the UE, new uplink grant signaling and enhanced Physical HARQ Indicator CHannel PHICH (ePHICH) information from the base station, wherein ePHICH resources are mapped to at least parts of time frequency resources of one or multiple distributed enhanced Physical Downlink Control Channel (ePDCCH) sets; and
if the uplink grant signaling is not detected, one of retransmitting and not transmitting, by the UE, the uplink data.

2. The method of claim 1, wherein a parameter of a distributed ePDCCH set used for an ePHICH is configured for the UE via high layer signaling, which comprises one of:
configuring only one distributed ePDCCH set used for the ePHICH, and mapping the ePHICH resources to the distributed ePDCCH set for the UE;
configuring multiple distributed ePDCCH sets used for the ePHICH, and mapping the ePHICH resources to the multiple distributed ePDCCH sets for the UE; and
configuring a distributed ePDCCH set used for the ePHICH for each distributed ePDCCH set in which a ePDCCH is detected by the UE, and uplink grant signaling in the distributed ePDCCH set mapping the ePHICH resources to the corresponding distributed ePDCCH set.

3. The method of claim 1, wherein the ePHICH resources are mapped to a distributed ePDCCH set used for carrying Common Search Space (CSS) for the UE.

4. The method of claim 3, wherein the ePDCCH and the ePHICH use a same DeModulation Reference Signals (DMRS) port, and a DMRS sequence is generated according to a same cell-specific indication.

5. The method of claim 1, wherein, when at least one distributed ePDCCH set in which an ePDCCH is detected is configured for the UE, the ePHICH resources are mapped to one of the distributed ePDCCH sets for the UE.

6. The method of claim 1, wherein, when more than one distributed ePDCCH set in which an ePDCCH is detected is configured for the UE, for uplink grant signaling in each distributed ePDCCH set, according to the synchronous HARQ timing relationship, the ePHICH resources are mapped to the distributed ePDCCH set, or, for uplink grant signaling in each distributed ePDCCH set, the ePHICH resources are mapped to the more than one distributed ePDCCH set.

7. The method of claim 1, wherein the ePHICH resources are one of centralized mapped to one distributed ePDCCH set and evenly mapped to multiple distributed ePDCCH sets.

8. The method of claim 7, further comprising one of:
configuring the number of the ePHICH resources on the ePDCCH set semi-statically; and
configuring the number of enhanced Control Channel Elements (eCCEs) on the ePDCCH set used for the ePHICH semi-statically.

9. The method of claim 7, further comprising:
configuring a maximum number of the ePHICH resources on the ePDCCH set semi-statically,
wherein an enhanced Control Channel Element (eCCE) not completely occupied by the ePHICH is able to transmit the ePDCCH dynamically.

10. The method of claim 9, wherein the maximum number of the ePHICH resources is implicitly determined according to a number of Physical Resource Blocks (PRBs) in uplink bandwidth and a weighting factor configured by a high layer.

11. The method of claim 9, wherein for Time Division Duplex (TDD) uplink downlink configuration 0, time frequency resources occupied by two ePHICH areas are assigned alternately.

12. The method of claim 1, wherein the ePHICH resources are carried by one enhanced Control Channel Element (eCCE) as one ePHICH group.

13. The method of claim 1, the method comprising:
configuring the number of ePHICH groups by a high layer signaling; the number of the ePHICH groups is the number of ePHICH groups in one ePDCCH set used for the ePHICH, or the number of the ePHICH group is the total number of ePHICH groups in all ePDCCH sets used for the ePHICH in the base station.

14. The method of claim 1, wherein the ePHICHs of the UE are mapped to only one distributed ePDCCH set.

15. The method of claim 14, wherein different offsets are used for the uplink grant signaling of different ePDCCH sets when the ePHICHs are mapped.

16. The method of claim 1, wherein the ePHICHs of the UE are mapped to multiple distributed ePDCCH sets.

17. The method of claim 14, wherein the ePHICH resources are mapped according to a minimum enhanced Control Channel Element (eCCE) index n_{eCCE} occupied by the uplink grant signaling and n_{DMRS} in the uplink grant signaling.

18. The method of claim 14, wherein the ePHICH resources are mapped according to a minimum Physical Resource Block (PRB) index of the PUSCH, a minimum enhanced Control Channel Element (eCCE) index n_{eCCE} occupied by the uplink grant signaling and n_{DMRS} in the uplink grant signaling.

19. A base station apparatus comprising:
a signal generating module configured to generate enhanced Physical Downlink Control CHannel (ePHICH) signals to be sent on ePHICH resources;
a multiplexing module configured to map the ePHICH signals to assigned time frequency resources of one or more distributed enhanced Physical Downlink Control CHannel (ePDCCH) sets used for sending the ePHICH;
a transmission module configured to transmit the mapped ePHICH signal.

20. A terminal device comprising:
a receiving module configured to detect and to receive a signal;
a demultiplexing module configured to demultiplex the ePHICH signal from time frequency resources of a corresponding distributed ePDCCH set;
a parsing module configured to parse the ePHICH signal and to obtain Hybrid Automatic Repeat Request (HARQ)-ACKnowledgement (ACK) information for uplink data.
